(19) United States
(12) Patent Application Publication
(10) Pub. No.: US 2002/0142188 A1
(43) Pub. Date: Oct. 3, 2002

(54) Illuminated imageable vision control panel

(76) Inventor: Michael D. Andriash, Kelowna (CA)

Correspondence Address: NIXON & VANDERHYE P.C., 8th Floor, 1100 North Glebe Road, Arlington, VA, 22201-4714, US

(21) Appl. No.: 09/824,558

(22) Filed: Apr. 3, 2001

(51) Int. Cl. H05B 33/00

(52) U.S. Cl. 428/690; 428/917; 428/195; 428/201; 428/209; 313/509; 313/510; 257/98; 257/88; 427/66

(57) ABSTRACT

The vision panel includes electroluminescent sheetstock having electrically energizable light-emitting and non-electrically energizable non-light emitting areas and terminals for electrically connecting the electrically energizable light-emitting areas to an electrical power source. The sheetstock is formed of layers of patterned phosphorus ink, a dielectric and a conductive material such as a conductive ink or conductive adhesive. A reflective sheet is applied to one side of the panel and a printed image is provided over a diffuser layer overlying the electroluminescent sheet on the opposite side of the panel. Upon electrical energization of the light-emitting areas, the image on one side of the panel is illuminated by light transmitted directly from the electrically energized light-emitting areas, as well as light reflected by the reflective sheet through the non-light-emitting areas and through the image.

### TECHNICAL FIELD

The present invention relates to an illuminated vision control panel having a self-illumination image formed of electroluminescent materials in which substantial uniformity of illumination of the image is afforded with substantial reductions in cost.

### BACKGROUND

In my prior U.S. patent application Ser. No. 09/245,929, filed Feb. 8, 1999, incorporated herein by reference, a two-way self-illuminating vision control panel is provided using e;ectroluminesecnt materials, i.e., electroluminescent sheetstock comprised of sheet electrode layers with an electroluminescent material such as phosphors therebetween. In that application, the electroluminescent layer is perforated to provide a two-way vision control panel wherein an illuminated image can be seen from one side of the panel, while an individual can see through the illuminated panel from the opposite side without seeing the image. One of the problems overcome in providing such panel was the halo effect of the luminescent material in the grid pattern. That is, the activated phosphor layer of the luminescent grid pattern would spill light into the non-light-emitting areas of the grid, causing a washed-out appearance of the image from the image viewing side of the panel and significantly impeding the see-through capability of the panel from the non-image side. That problem was overcome in that panel by applying an opaque coating to the margins in the grid pattern between the light-emitting and non-light-emitting portions whereby the spillover effect of light from the light-emitting portions into the non-light-emitting portions. i.e., the halo effect, was precluded. Another solution to that problem included setting back the margins of the light-emitting portions from the margins of the non-light-emitting portions in the grid pattern such that the margins of the non-light-emitting portions substantially blocked the spillover light from view from either side of the panel.

Substantial benefit accrues from using electroluminescent panels of that type. For example, the printing process for forming the image may be any one of a number of conventional processes. However, a disadvantage of employing electroluminescent materials is their relatively high cost. It will be appreciated that the phosphor and dielectric materials are significant cost components of electroluminescent sheetstock. Accordingly, there is a need for a vision control panel employing electroluminescent material which is of reduced cost and which need not necessarily have a transparency from the non-image side of the panel.

### DISCLOSURE OF THE INVENTION

In accordance with a preferred embodiment of the present invention, there is provided a vision control panel formed of electroluminescent material in which variable and substantially reduced quantities of the higher-cost materials forming the electroluminescent panel may be used while simultaneously affording substantial uniform light distribution and intensity for illuminating the image comparable to the light distribution and intensity of conventional electroluminescent panels. To accomplish the foregoing, a first electrode may be formed of an optically clear layer or sheet, e.g., a clear indium, tin, oxide (ITO) sheet with a patterned phosphor layer formed on one side. Preferably, the phosphor layer is printed in a grid pattern which may comprise electrically energizable light-emitting and non-electrically energized non-light-emitting areas or portions. A dielectric layer is applied in an identical and registering grid pattern to the printed phosphor layer. In a preferred form of the present invention, a layer of identically patterned conductive ink overlies, i.e., is printed on, and in registration with, the dielectric layer and forms the second electrode. Overlying the patterned conductive ink layer, i.e., the second electrode, is a relatively inexpensive, non-patterned sheet of highly reflective material. For example, the sheet may be formed of aluminum, have a silvered surface or have a highly reflective colored surface laminated to the second electrode. Preferably, a white translucent layer overlies the ITO layer on the side of the electroluminescent sheetstock opposite the reflective non-patterned sheet to provide a diffusion of the directly transmitted and reflected light upon activation of the panel. An image may then be formed over the white translucent diffuser layer and which image is illuminated by the electroluminescent sheetstock upon electrical activation thereof. Alternatively, the image may be formed directly over the ITO layer without the light diffusing layer. In either case, the image is applied to the panel by any one of conventional printing processes. A protective transparent overlay may then be applied over the image layer using suitable clear adhesives as desired.

It will be appreciated that electrical energization of the patterned phosphorus ink layer printed on the ITO layer causes the electrically energized light-emitting areas to emit light in opposite directions toward the image and reflective sheet layers, respectively. Those light-emitting layers also transmit light into the non-electrically energized non-light-emitting portions or areas of the grid pattern adjacent to and bounded by the light-emitting areas. This light transmitted into the adjacent non-light-emitting areas is reflected by the reflective sheet toward the image side of the sheetstock. As a consequence, the translucent materials overlying the opposite side of the sheetstock forming the image are viewable as an image illuminated by light transmitted both directly from the electrically energized light-emitting portions or areas and light transmitted from the light-emitting areas into the non-light-emitting areas, which is reflected from the reflective sheet. In a preferred embodiment, the white translucent diffuser layer diffuses the light such that an appearance of a substantially uniformly illuminated image is provided on the image side of the control panel. It will be appreciated that the panel thus formed constitutes a highly flexible, very thin sheet which can be applied to almost any surface, for example, by adhesives applied to the back side of the reflective sheet. For example, pressure-sensitive adhesive with an overlay of release paper may be provided whereby, upon removal of the release paper, the panel may be adhered to the surface. The sheet can also conform to irregular or curved surfaces due to its flexibility. Specific examples of usage of the sheet are billboards, storefront displays, and signage in general.

Substantial savings are incurred in the formation of the foregoing described panel. For example, the high cost of materials, such as the phosphor, silver (used in the conductive ink) and dielectric material are omitted in the non-light-emitting areas of the grid pattern. To the extent those materials are omitted in the fabrication of the panel, the cost of the panel is substantially reduced. Additionally, the ratio of the light-emitting to non-light-emitting areas provided in the grid pattern can be altered during the fabrication process. This is highly beneficial to an end user of the panel who may wish a panel for short-term use and not for the long-term life of a conventional electroluminescent panel which does not have a grid pattern of electrically energized and non-electrically energized areas. Thus, where the ratio of light-emitting to non-light-emitting portions, i.e., ratio of high-cost materials to low-cost materials, is low, the end-user may employ a panel of substantially reduced cost while affording substantially comparable illumination as a solid sheet (without a grid pattern) of electroluminescent material would provide, at only a marginal increase in the cost of electricity. Consequently, an electroluminescent vision panel can be made-to-order, dependent upon the desired life expectancy of the panel without, or barely discernible, reduction in the illumination and intensity of the image and at substantial cost savings.

In another embodiment of the present invention, instead of a patterned conductive ink, a patterned conductive adhesive may be applied in overlying relation to and in registration with the patterned dielectric. The adhesive, of course, secures the reflective sheet to the dielectric material and simultaneously serves as the second electrode.

In a preferred embodiment according to the present invention, there is provided a vision panel comprising sheetstock having electrically energizable light-emitting and non-electrically energizable non-light-emitting areas, terminals for electrically connecting the electrically energizable light-emitting areas to an electrical power source, the electrically energizable light-emitting areas and the non-electrically energizable non-light-emitting areas lying adjacent one another such that light from the light-emitting areas, upon electrical energization thereof, is transmitted into the non-electrically energizable non-light-emitting areas of the sheetstock, a sheet of reflective material overlying at least the non-electrically energizable non-light-emitting areas on one side of the sheetstock for reflecting the light transmitted into the non-electrically energizable non-light-emitting areas toward an opposite side of the sheetstock and translucent materials overlying the opposite side of the sheetstock forming an image thereon viewable from the opposite side of the sheetstock as an image illuminated by light transmitted directly from the electrically energized light-emitting areas and light reflected by the reflective sheet.

In a further preferred embodiment according to the present invention, there is provided a vision panel comprising sheetstock including a pair of electrode layers separated one from the other by a layer of electrically energizable light-emitting material arranged in a grid pattern defining light-emitting portions and transparent non-light-emitting portions when electrically energized, the light-emitting and non-light-emitting portions lying adjacent one another such that light from the light-emitting portions, upon electrical energization of the electrode layers, is transmitted into the non-light-emitting portions of the sheetstock, a light-reflective sheet overlying at least the non-light-emitting portions on one side of the sheetstock for reflecting light transmitted into the non-light-emitting portions from the light-emitting portions toward an opposite side of the sheetstock, one of the electrode layers on a side of another of the electrode layers remote from the reflective sheet being transparent and translucent materials overlying the opposite side of the sheetstock forming an image thereon viewable from the opposite side of the sheetstock as an image illuminated by light transmitted directly from the light-emitting portions and light reflected by the reflective sheet.

In a further preferred embodiment according to the present invention, there is provided a method of forming a vision control panel, comprising the steps of (a) printing on a clear sheet having an indium, tin, oxide film a grid pattern of phosphorus ink, (b) printing a dielectric in a grid pattern onto the phosphorus ink, (c) printing a grid pattern of a conductive material onto the dielectric, (d) the steps (b) and (c) being performed such that the grid patterns of the phosphorus ink, dielectric and conductive material register one with the other, (e) securing a reflective sheet on the side of the panel opposite the clear sheet and (f) forming an image on the side of the panel opposite the reflective sheet.

### BRIEF DESCRIPTION OF THE DRAWING

FIG. 1 is an exploded schematic illustration of the various layers of materials forming an illuminated imageable vision control panel in accordance with a preferred embodiment of the present invention;

FIG. 2 is a fragmentary enlarged cross-sectional view of a panel hereof; and

FIG. 3 is a view similar to FIG. 2 illustrating another embodiment of the invention.

### BEST MODE FOR CARRYING OUT THE INVENTION

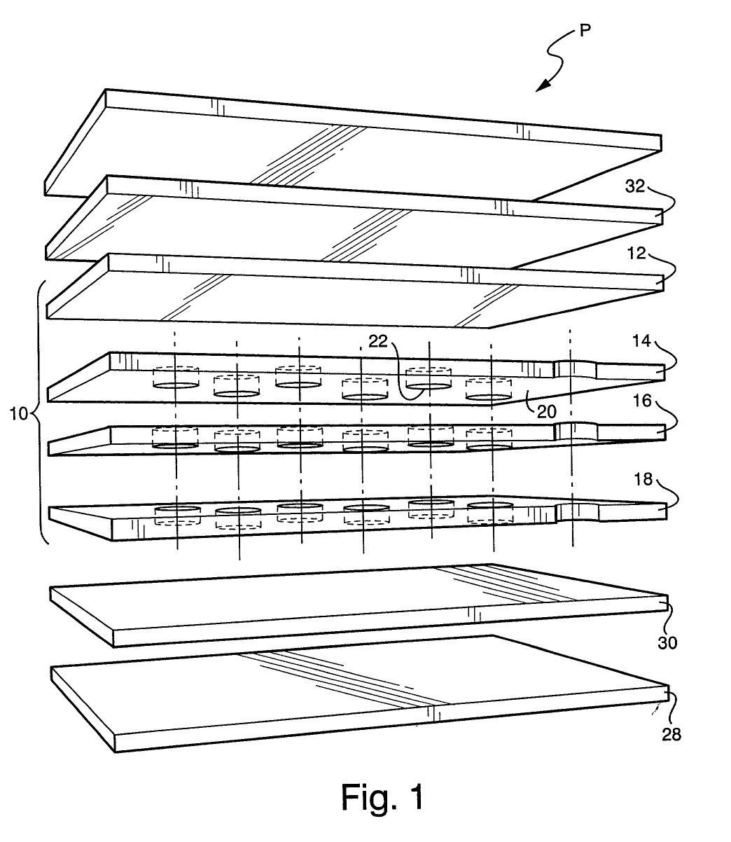

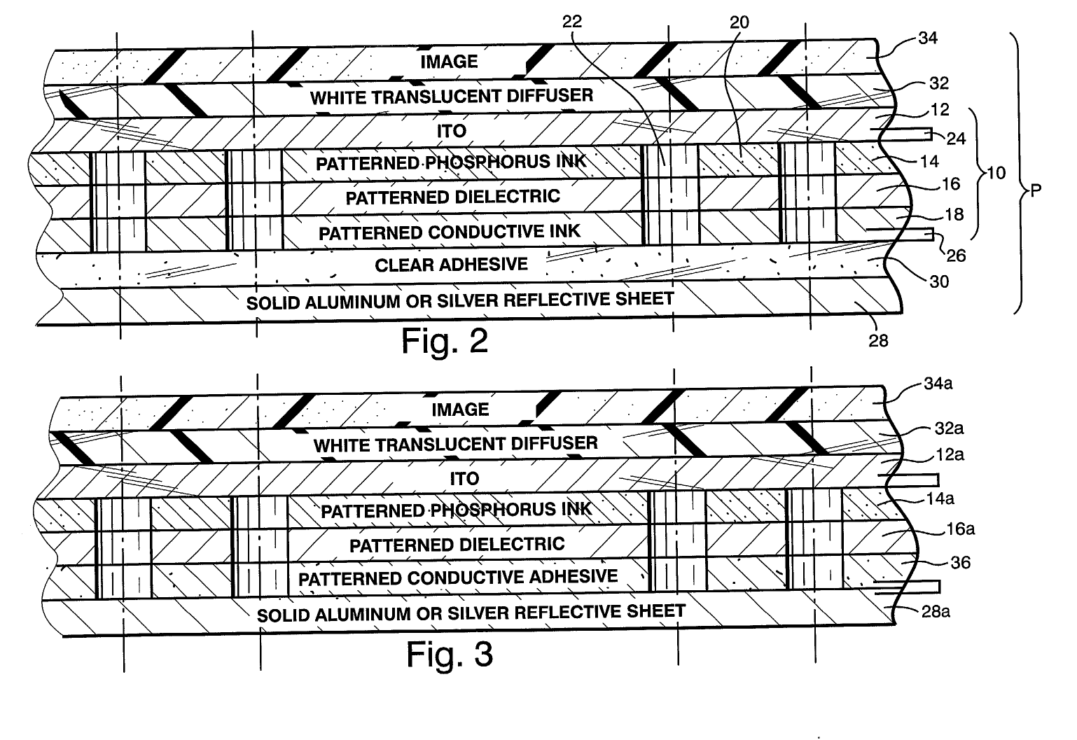

Referring now to the drawings, particularly to FIGS. 1 and 2, there is schematically illustrated various layers of materials used in the fabrication process to form an illuminated imageable vision control panel according to the present invention and generally designated P. The panel P is formed of a combination of specially fabricated electroluminescent sheetstock 10 and various overlying and underlying materials. The sheetstock 10 in a first embodiment hereof is comprised of a first electrode sheet 12 formed preferably of a clear polyester sheet having an ITO film, i.e., an indium, tin, oxide film sputtered onto the sheet and which sheet 12 is commercially available. To fabricate the special electroluminescent sheetstock 10, a patterned ink, preferably a phosphorus ink, is applied to one side, e.g., the underside in the illustrated version, of the ITO sheet 12. A dielectric layer 16 is applied to the patterned ink layer 14, along its underside as illustrated, forming an insulator between the patterned ink layer 14 and a further patterned conductive ink layer 18 overlying the dielectric layer 16.

The patterns of the phosphorus ink, dielectric and conductive ink layers 14, 16 and 18 are identical to one another and may comprise any desired pattern, such as a grid pattern. It will be appreciated that whatever grid pattern is utilized, the phosphorus ink, dielectric and conductive ink layers 14, 16 and 18, respectively, have identical patterns in registration with one another. The patterns may be of any type provided the phosphorus ink pattern of layer 14 forms an array of discrete electrically energizable light-emitting and non-electrically energized non-light-emitting areas or portions 20 and 22, respectively. The non-light-emitting areas 22 comprise areas along the ITO sheet 12 where the phosphorus ink has not been applied. Such areas are preferably bounded by the electrically energized light-emitting areas 20, i.e., areas where the phosphorus ink has been applied to the ITO sheet 12. For example, a grid pattern with the non-light-emitting areas in the form of circles, square, triangles, polygons, stripes or the like, surrounded or bounded by electrically-energizable light-emitting areas 20 may be provided. The non-light-emitting areas 22 may be of other shapes or configurations. While preferably a regular patterned array of light-emitting and non-light-emitting areas 20 and 22, respectively, is provided, it will be appreciated that the array may also be irregular in shape and/or configuration. Thus, the regular patterned array of circles shown in the drawing figures is representative only and not limiting.

Moreover, the ratio of the electrically-energizable light-emitting areas 20 to the non-electrically energized, non-light-emitting areas 22 may be varied, depending upon the needs of the end user. For example, the phosphorus ink layer 14 may have a 50-50 ratio of light-emitting to non-light-emitting areas. That ratio can be varied, depending on the end user requirements. For example, an 80-20 ratio or a 20-80 ratio of light-emitting to non-light-emitting area can be provided in the grid pattern. Different ratios therebetween may also be used.

To fabricate the electroluminescent sheetstock 10, the phosphorus ink layer may be printed onto the ITO sheet 12. For example, the desired grid pattern may initially be generated by a computer-generated drawing, for example, and printed, e.g., by an ink-jet printer, on a clear substrate, printing black in the desired pattern and clear where the non-light-emitting area is to be formed. The printed grid pattern is then burned onto a silkscreen and the phosphorus ink is then silkscreened onto the ITO sheet 12, forming the light-emitting and non-light-emitting areas 20 and 22 in the desired pattern. It will be appreciated that the sheet 12 is a polyester sheet with an indium, tin, oxide (ITO) film sputtered onto the sheet. As a result, a grid pattern is provided in sheet 12 having areas of the phosphor ink forming light-emitting areas or portions 20 and areas not provided with the phosphor ink forming the non-light-emitting areas 22. Next, the dielectric layer 16 is similarly printed on sheet 12 in registration with and overlying the patterned phosphorus ink layer previously printed on sheet 12. Following this, an identically patterned conductive ink is likewise printed in registration with and overlying the patterned dielectric layer. The phosphorus ink on sheet 12 and conductive ink layers may be electrically connected by bus bars 24 and 26, respectively, (FIG. 2) to an A.C. power source, not shown.

It will be appreciated that upon electrical energization of the electroluminescent sheetstock, the phosphorus ink is energized in the light-emitting areas 20 and light is therefore emitted. The areas of the phosphorus ink layer 14 defined by the grid pattern and which do not contain the phosphorus ink are not electrically energized and therefore do not emit light. Light, however, from the energized light-emitting areas 20 is transmitted, i.e., spills over, into the adjacent non-light-emitting, non-electrically energized areas 22.

In accordance with a preferred embodiment of the present invention, a highly reflective sheet 28 is secured on the side of the patterned layers 14, 16 and 18 remote from the ITO sheet 12 and preferably by a clear adhesive 30. While the sheet 28 can be similarly patterned as layers 14, 16 and 18 with reflective surface areas applied in registration with only the non-light-emitting areas 22, preferably a non-patterned reflective sheet is provided, which reflective surface overlies both the light-emitting and non-light-emitting areas 20 and 22, respectively. Consequently, light from the electrically energized light-emitting areas 20 of the phosphorus ink layer will be transmitted directly through the clear ITO sheet 12. In addition, the light transmitted generally into the non-light-emitting areas 22 will be reflected by the reflective sheet for transmission similarly through the ITO sheet 12. Preferably, a white translucent layer 32 overlies the ITO sheet 12 on a side thereof remote from the grid pattern and diffuses the transmitted light from the light-emitting areas 20 and the reflected light passing through the non-light-emitting areas 22. It will be appreciated that the light translucent diffuser layer 30 may be overlaid with a printed image 34 either upon initial fabrication of the panel or by an end user of the panel. Any type of conventional printing may be employed to provide the desired image. For example, electrostatic transfer, thermal transfer, ink-jet printing or any other type of printing may be provided to form an image.

From the foregoing, it will be appreciated that upon energization of the electroluminescent sheetstock, the image layer 34 is illuminated from its back side by light transmitted directly from the light-emitting areas 20 and reflected light transmitted from the reflective sheet through the non-light-emitting areas 22 and the diffuser layer 32. It will therefore be appreciated that the illumination of the image is substantially uniform over the entire surface of the image and any variations in intensity of the light transmitted through the image due to the nature of the transmitted light, i.e., direct transmission or reflected transmission, will not be readily discernible to the user. It will also be appreciated that the image can be printed directly onto the ITO sheet 12 without any intervening light-translucent diffuser layer 32. The diffuser layer, of course, diffuses the directly transmitted and reflective light such that the light passing through the imaged layer appears substantially uniform to the viewer over the entire image surface.

From the foregoing, it will also be appreciated that the cost savings in the formation of the electroluminescent sheet 10 are substantial. The principal costs in the formation of an electroluminescent panel lie in the phosphors, the dielectric material and silver (the silver forms part of the conductive ink layer 18). Consequently, by reducing the quantity of those materials utilized in the electroluminescent sheetstock 10 by forming non-light-emitting areas, which through a printing process, do not contain such materials, substantial cost savings are achieved. For a given illumination or light intensity, the electroluminescent panel 10 hereof may use marginally more electricity than a conventional electroluminescent panel formed without non-light-emitting areas, i.e., a panel employing 100% electrically energizable light-emitting materials throughout the extent of the panel. However, an end user may require an electroluminescent panel for only a short period of time, i.e., a period of time shorter than the life expectancy of a conventional electroluminescent panel. The initial cost savings in the cost of the panel very substantially more than offset any increase in electricity costs and therefore provide a panel useful over a predetermined time period at reduced costs.

In the form of the invention illustrated in FIG. 3, wherein like reference numerals are applied to like parts followed by the suffix “a,” instead of a patterned conductive ink layer 18 which employs substantial silver, a patterned conductive adhesive layer 36 may be provided overlying the patterned dielectric. Thus, the patterned conductive adhesive lies between the dielectric layer 16a and the reflective sheet 28a and serves the dual purpose of a second electrode in the panel as well as adhering the reflective sheet 28 to the panel.

In both embodiments, it will be appreciated that the electrically-energizable, light-emitting areas 20 bound the non-electrically energized, non-light-emitting areas of the sheetstock. To the extent the materials forming the light-emitting areas 22 are omitted in the non-light-emitting areas, there is substantial cost savings while simultaneously substantially the same magnitude and intensity of illumination of the image. Also, it will be appreciated that the flexible panel can be readily applied to various surfaces, flat or curvilinear. For example, a pressure-sensitive adhesive can be applied to the back side of the reflective sheet 28 with an overlying release paper. Upon removal of the release paper, the panel P can be readily adhered to the surface.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A vision panel comprising:
sheetstock having electrically energizable light-emitting and non-electrically energizable non-light-emitting areas;
terminals for electrically connecting the electrically energizable light-emitting areas to an electrical power source;
said electrically energizable light-emitting areas and said non-electrically energizable non-light-emitting areas lying adjacent one another such that light from said light-emitting areas, upon electrical energization thereof, is transmitted into said non-electrically energizable non-light-emitting areas of said sheetstock;
a sheet of reflective material overlying at least said non-electrically energizable non-light-emitting areas on one side of said sheetstock for reflecting the light transmitted into said non-electrically energizable non-light-emitting areas toward an opposite side of said sheetstock; and
translucent materials overlying said opposite side of said sheetstock forming an image thereon viewable from said opposite side of said sheetstock as an image illuminated by light transmitted directly from said electrically energized light-emitting areas and light reflected by said reflective sheet.

2. A panel according to claim 1 wherein said light-emitting and non-light-emitting areas include patterned ink layers separated by a dielectric.

3. A panel according to claim 2 wherein said dielectric includes a patterned dielectric layer, said patterned ink layers and said patterned dielectric layer lying in registration with one another.

4. A panel according to claim 1 wherein said light-reflective sheet includes an aluminum sheet.

5. A panel according to claim 1 wherein said light-reflective sheet includes a silvered sheet.

6. A panel according to claim 1 wherein said light-emitting and non-light-emitting areas include a patterned ink layer and a patterned dielectric layer, the patterns of each said layers registering one with the other.

7. A panel according to claim 6 including a patterned electrical conductive adhesive layer in registration with said registering patterned ink and dielectric layers.

8. A panel according to claim 1 wherein said light-emitting and non-light-emitting areas include a patterned phosphorus ink layer, a patterned conductive ink layer and a patterned dielectric ink layer therebetween, said patterned layers lying in registration with one another.

9. A panel according to claim 1 wherein said non-electrically energizable non-light-emitting areas include areas bounded by electrically energizable light-emitting areas.

10. A panel according to claim 1 wherein said electrical energizable light-emitting areas include areas bounded by non-electrical energizable non-light-emitting areas.

11. A panel according to claim 1 wherein said sheet of reflective material overlies said non-electrically energizable, non-light-emitting areas and said electrically energizable light-emitting areas.

12. A vision panel comprising:
sheetstock including a pair of electrode layers separated one from the other by a layer of electrically energizable light-emitting material arranged in a grid pattern defining light-emitting portions and transparent non-light-emitting portions when electrically energized;
said light-emitting and non-light-emitting portions lying adjacent one another such that light from said light-emitting portions, upon electrical energization of said electrode layers, is transmitted into said non-light-emitting portions of said sheetstock;
a light-reflective sheet overlying at least said non-light-emitting portions on one side of said sheetstock for reflecting light transmitted into said non-light-emitting portions from said light-emitting portions toward an opposite side of said sheetstock;
one of said electrode layers on a side of another of said electrode layers remote from said reflective sheet being transparent; and
translucent materials overlying said opposite side of said sheetstock forming an image thereon viewable from said opposite side of said sheetstock as an image illuminated by light transmitted directly from said light-emitting portions and light reflected by said reflective sheet.

13. A panel according to claim 12 including a translucent layer overlying said sheetstock on said opposite side thereof for diffusing light transmitted from said light-emitting and non-light-emitting portions to afford the appearance of a substantially uniformly illuminated image.

14. A panel according to claim 12 including a dielectric between said electrode layers arranged in a grid pattern in registration with said grid pattern of said light-emitting portions of said layer of electrically energizable light-emitting material.

15. A panel according to claim 12 wherein one of said electrode layers includes a phosphorus patterned ink.

16. A panel according to claim 12 wherein one of said electrode layers includes a patterned adhesive layer.

17. A method of forming a vision control panel, comprising the steps of:
(a) printing on a clear sheet having an indium, tin, oxide film a grid pattern of phosphorus ink;
(b) printing a dielectric in a grid pattern onto the phosphorus ink;
(c) printing a grid pattern of a conductive material onto the dielectric;
(d) the steps (b) and (c) being performed such that the grid patterns of the phosphorus ink, dielectric and conductive material register one with the other;
(e) securing a reflective sheet on the side of the panel opposite the clear sheet; and
(f) forming an image on the side of the panel opposite the reflective sheet.

18. A method according to claim 17 wherein the conductive material comprises a conductive ink and further including the step of securing the reflective sheet onto the panel using a clear adhesive.

19. A method according to claim 17 wherein the conductive material comprises a patterned conductive adhesive and including securing the reflective sheet to the panel using the patterned conductive adhesive.
